(19) United States
(12) Patent Application Publication
(10) Pub. No.: US 2021/0190033 A1
(43) Pub. Date: Jun. 24, 2021

(54) A WIND TURBINE WITH AN ENERGY GENERATING UNIT, AND AN ENERGY GENERATING UNIT FOR A WIND TURBINE

(71) Applicant: Vestas Wind Systems A/S, Aarhus N. (DK)

(72) Inventors: Torben Ladegaard Baun, Skødstrup (DK); Jesper Lykkegaard Neubauer, Hornslet (DK)

(21) Appl. No.: 16/771,840

(22) PCT Filed: Dec. 20, 2018
(86) PCT No.: PCT/DK2018/050419

§ 371 Date: Jun. 11, 2020

(30) Foreign Application Priority Data
Dec. 22, 2017 (DK) PA 2017 71024

(51) Int. Cl. F03D 1/02; F03D 13/20

(52) U.S. Cl. CPC F03D 1/02; F03D 80/70; F03D 13/20

(57) ABSTRACT

The invention provides a wind turbine comprising a load carrying structure and an energy generating unit. The load carrying structure is connected to the energy generating unit and holds the energy generating unit above ground. The energy generating unit houses a facility which requires a particular orientation relative to gravity for being operational. Furthermore, the energy generating unit comprises an adaptation structure e.g. arranged between the load carrying structure and the facility. The adaptation structure facilitates a first configuration with a first position of the facility relative to the load carrying structure, and a second configuration with a second position of the facility relative to the load carrying structure.

### FIELD OF THE INVENTION

The disclosure relates to a wind turbine comprising a load carrying structure and an energy generating unit. The load carrying structure may e.g. be in the form of a vertical tower typically used on horizontal axis wind turbines, or in the form of a non-vertical arm typically used on multiple rotor wind turbines.

The load carrying structure holds the energy generating unit above ground, and the energy generating unit houses a facility, a rotor shaft and a main frame. The main frame transfer load between the rotor shaft and the load carrying structure and the rotor shaft forms a rotor axis for rotation of the hub, blades, and optionally power generating components of the drive train. The facility is a component which needs a particular orientation relative to gravity.

The invention further relates to an energy generating unit and to a method of configuring an energy generating unit to a wind turbine load carrying structure.

### BACKGROUND OF THE INVENTION

In wind turbines, wind energy is converted into mechanical energy by blades carried by a hub. The hub is carried by a shaft.

The size and weight of the wind turbine tower, energy generating unit, blades, and drive train have increased over the years and manufacturing, transport, and assembly of the wind turbines have become more and more challenging.

Modern wind turbines may include towers more than 100 meters tall when installed. The energy generating unit houses at least the major parts of the drive train, i.e. with the hub and blades extending from one end of the energy generating unit. Various components are housed within the energy generating unit, e.g. a gearbox and generator.

A conventional approach for assembly of wind turbines is to design an energy generating unit matching a specific load carrying structure.

### DESCRIPTION OF THE INVENTION

It is an object of the present disclosure to increase flexibility with respect to assembly and servicing of wind turbines, to facilitate manufacturing and logistics in handling of energy generating units for wind turbine, and to enable a modular design of wind turbines.

According to these and other objects, the disclosure, in a first aspect, provides a wind turbine, in a second aspect provides an energy generating unit, and in a third aspect provides a method for assembling or servicing a wind turbine according to the independent claims.

The two positions allow reconfiguration of the energy generating unit between configurations where the energy generating unit is carried in different ways by the load carrying structure. One and the same energy generating may e.g. be carried below the rotor shaft and the facility be positioned correctly relative to the requirements to orient it relative to gravity, and it may be carried sideways or above the rotor shaft and the facility be repositioned to again correctly orient it relative to gravity. Since the facility can maintain a constant orientation relative to gravity we, herein, refer to the facility being ‘stationary’ while the load carrying structure may shifted between different configurations depending on the type of wind turbine. In the following, we refer to those parts following the facility as ‘stationary parts’ and those parts not following the facility as ‘non-stationary parts’.

Due to the reconfiguration of the energy generating unit, identically produced energy generating units could be configured differently and used e.g. in connection with different wind turbine types. In one implementation, the wind turbine is a traditional horizontal axis wind turbine where the load carrying structure is a vertical tower terminating with an energy generating unit at the top. In another implementation, the wind turbine is a multiple rotor wind turbine and the load carrying structure is a non-vertical arm carried by a vertical tower and holding one or more energy generating units.

The configurability thereby allows a high number of identical items, and the configurability therefore facilitates easier and cheaper manufacturing and logistics.

The skilled person would readily recognise that any feature described in combination with the first aspect of the disclosure could also be combined with the second and third aspects of the disclosure, and vice versa.

In the present context the terms ‘multirotor wind turbine’ and ‘multiple rotor wind turbine’ should be interpreted to mean a wind turbine comprising two or more rotors or energy generating units mounted on one tower. The load carrying structure is arranged for supporting at least one of the at least two energy generating units and for being connected to a tower of the multirotor wind turbine. Typically, two load carrying structures are arranged on load carrying structures extending outwards on opposite sides of the tower to thereby balance forces and loads with respect to the tower.

In the present context the terms ‘single rotor wind turbine’ should be interpreted to mean a wind turbine of the traditional horizontal axis type comprising an energy generating unit on top of a tower which therefore constitutes the load carrying structure.

In the present context the term ‘energy generating unit’ should be interpreted to mean a part of the wind turbine which actually transforms the energy of the wind into electrical energy. The traditionally used term, “nacelle” would cover an energy generating unit but without the hub and rotor which herein forms part of the energy generating unit.

Each energy generating unit thereby typically comprises a hub carrying a set of wind turbine blades, a generator, and a rotor shaft connecting the generator and the hub. The energy generating unit may further comprise a gear arrangement interconnecting the rotor shaft and the generator. The generator, and possibly the gear arrangement, may be arranged inside a nacelle. In one embodiment, the unit forms a direct drive without a gear arrangement, and in one embodiment, the hub with blades rotates relative to a fixed shaft, and the generator is embedded between the hub and fixed shaft. Herein, the term ‘drive train’ should be interpreted to mean the group of components that deliver power to the generator.

In the present context the term ‘rotor shaft’ is the rotating shaft which joins the hub and blades with the components which transform the wind energy into electrical energy. The rotor shaft may e.g. extend between the hub and a gearbox or generator.

The rotor shaft typically forms part of a drive train. The drive train may have a stator part capable of holding the rotor shaft. The stator part could be constituted by a main frame, and the main frame may include one or more main bearings forming rotational suspension for the rotor shaft. The main bearing could be referred to as a stator, or the main frame with bearings could be referred to as a stator.

The main frame is configured to transfer load from the rotor shaft to the load carrying structure. The main frame may e.g. have a main flange by which it can be bolted onto the load carrying structure. The main frame may typically be constituted by a large and heavy casted iron component or it may be formed by a lattice structure on which the main bearing is fixed.

It is typically desirable to allow rotation of the main frame relative to the load carrying structure. Such rotation may e.g. position the blades against the wind etc. The main frame may therefore be connected to the load carrying structure via a yaw bearing.

For structural rigidity, it is, however, typically desired to provide a solid fixation of the main frame relative to the load carrying structure. Except for the optional yaw bearing, it may therefore be desired to keep the position of the main frame fixed relative to the load carrying structure. Accordingly, the main frame may constitute a non-stationary part as opposed to the facility which constitutes a stationary part.

To maintain stability and a fixed position of the main frame on the load carrying structure, the adaptation structure may particularly be located such that it connects the facility to the load carrying structure via the main frame and wherein the first configuration provides a first position of the facility relative to the load carrying structure and the main frame, and the second configuration provides a second position of the facility relative to the load carrying structure and the main frame.

The adaptation structure may in one embodiment form part of the main frame. Alternatively, the adaptation structure may form part of or may constitute the main bearing system. Alternatively, the adaptation structure may form part of an exterior housing, i.e. a nacelle cover, which encloses the facility. Alternatively, the adaptation structure may form a separate adapter component inserted between the energy generating unit and the load carrying structure or inserted between the main frame and the facility.

The adaptation structure may enable movement of the facility relative to the load carrying structure at a predefined angle, a number of predefined angles, or an arbitrary angle. The movement may be horizontal, vertical, or both. If the facility is constituted by the drive train, the rotational part may define an axis of rotation, where the angle of the axis of rotation in the first position is moved relative to the axis of rotation in the second position. This relative movement may e.g. be obtained by forming the adaptation structure by a spherical bearing or by including a spherical bearing in the adaptation structure.

The first position and the second position may e.g. provide different positions of the facility around the axis of rotation. This could be different positions having the same radial distance to the axis of rotation, it could be different positions having different radial distance to the axis of rotation and having the same angular displacement about the axis of rotation, or it could be different positions having different radial distance to the axis of rotation and having different angular displacement about the axis of rotation.

The adaptation structure may have a first height about ground in the first configuration and a second height about ground in the second configuration.

One of the first and second positions could be a position where the adaptation structure is located between the rotor shaft and ground and the other one of the first and second positions could be a position where the adaptation structure is not located between the rotor shaft and ground.

The facility may comprise at least one element selected from the group consisting of: “a component configured for cooling equipment in the energy generating unit, a component configured for lubricating equipment in the energy generating unit, a component configured for electrical control of equipment in the energy generating unit, a component configured for electrical communication between the energy generating unit and external entities, a working platform configured for support of workers in the energy generating unit, and a sheathing forming encapsulation of at least a part of the drive train, or a fixture holding at least a part of the drive train, a gearbox between the rotor shaft and a generator, and a generator”. These parts may all constitute a stationary part.

The nacelle cover which forms an encapsulation of at least a part of the drive train may either form part of the facility and therefore be reoriented or repositioned via the adaptation structure. I.e. the nacelle cover may also constitute a stationary part. Alternatively, the nacelle cover is fixed to the main frame, to the load carrying structure or to other parts which are not influenced by the reorientation or repositioning via the adaptation structure and thereby constitute a non-stationary part.

The gearbox and the generator, may likewise form part of the facility and therefore be reoriented or repositioned via the adaptation structure. I.e. the gearbox and generator may also constitute a stationary part. Alternatively, the gearbox and/or generator are fixed to the main frame, to the load carrying structure or to other parts which are not influenced by the reorientation or repositioning via the adaptation structure and thereby constitute non-stationary parts.

The first position and the second position may provide different orientations of the facility relative to the load carrying structure. As an example, the facility may be arranged on top of the load carrying structure in the first position, whereas the facility may be arranged adjacent to the load carrying structure in the second position, or vice versa. It should further be understood, that the orientations are not limited to above and adjacent. Furthermore, the first and second positions may also include tilting of the facility at an angle relative to the load carrying structure.

To facilitate positioning of the facility relative to the load carrying structure, the adaptation structure may facilitate sliding of the facility relative to the load carrying structure and locking of the sliding in a plurality of positions of the facility relative to the load carrying structure.

Alternatively, the facility could be released from the load carrying structure or from the main frame and by use of a crane be lifted from the first to the second position and fixed via the adaptation structure.

The adaptation structure may comprise a first engagement structure matching a second engagement structure at one of the load carrying structure and the facility, whereas the adaptation structure may be fixedly attached to the other one of the load carrying structure and the facility. The plurality of positions may be an indefinite number of positions. The matching first and second engagement structures may facilitate that the facility can slide relative to the load carrying structure until the required position is reached. Consequently, a larger tolerance may be allowed during positioning as fine tuning of the positioning may be achieved by the sliding. Sliding may further provide an indefinite number of positions.

When the required position of the facility relative to the load carrying structure is achieved, the position may be locked in one of the plurality of positions.

The adaptation structure may form a first flange facilitating attachment of the facility in the first position relative to the load carrying structure and a second flange facilitating attachment of the facility in the second position relative to the load carrying structure. By providing the facility with an adaptation structure forming at least two differently oriented flanges, a single facility may be positioned in at least to different orientation relative to the load carrying structure, e.g. above and adjacent to the load carrying structure. By providing the flanges with a high number of attachment possibilities, a high number of locking positions may be achieved.

The adaptation structure may comprise a separate adapter component which is inserted between the load carrying structure and the facility. The separate adapter component may e.g. be inserted between the main frame and the facility. The adapter component may adapt the shape, size, or location of the load carrying structure to the shape, size, or location of the facility.

In one embodiment, the adapter component is configured as an interface between the energy generating unit and the load carrying structure. The wind turbine may further comprise a tension element, e.g. a guy wire, extending from the tower to the adapter component to support the wind turbine.

Alternatively, the adapter component is located between the load carrying structure and the main frame.

The adapter component may form a lattice structure or a casted structure.

The adapter component may as an example be arranged at a side of the facility and/or at the top of the facility, thereby not hindering access to the bottom zone of the facility and enabling downwards exchange of elements.

In at least one of the first and second positions, the facility may be located between the adapter component and ground. Thereby at least one of the first and positions may ensure that the adapter component is located above the facility so that access to the bottom of the facility is not hindered. This will enable downwards exchange of elements in the at least one position.

In a further alternative, at least one of the first and second positions may be a position where the adaptation structure is located between the facility and ground. In this embodiment, the top part of the facility may be free and thereby provide access to the facility thereby enabling upwards exchange of elements.

In the method according to the third aspect of the disclosure, the selection of configuration is made depending on a layout of the load carrying structure. If the load carrying structure is non-vertical, e.g. for a multirotor wind turbine, one configuration could be made, and if the load carrying structure is vertical, e.g. for a single rotor wind turbine, another configuration could be chosen.

### BRIEF DESCRIPTION OF THE DRAWINGS

The invention will now be described in further detail with reference to the accompanying drawings in which

FIG. 1 illustrates a multiple rotor wind turbine;

FIG. 2 illustrates a schematic view of parts of an energy generating unit;

FIG. 3 illustrates a schematic view of parts of an alternative energy generating unit;

FIG. 4 illustrates a front view with indication of different positions of the facility relative to the load carrying structure;

FIG. 5 illustrates a main frame for a drive shaft;

FIGS. 6A-6C illustrate a facility located in different positions relative to a load carrying structure;

FIG. 7 illustrates different adapter components; and

FIG. 8 illustrates an embodiment of a facility.

### DETAILED DESCRIPTION OF THE DRAWINGS

It should be understood that the detailed description and specific examples, while indicating embodiments of the invention, are given by way of illustration only, since various changes and modifications within the spirit and scope of the invention will become apparent to those skilled in the art from this detailed description.

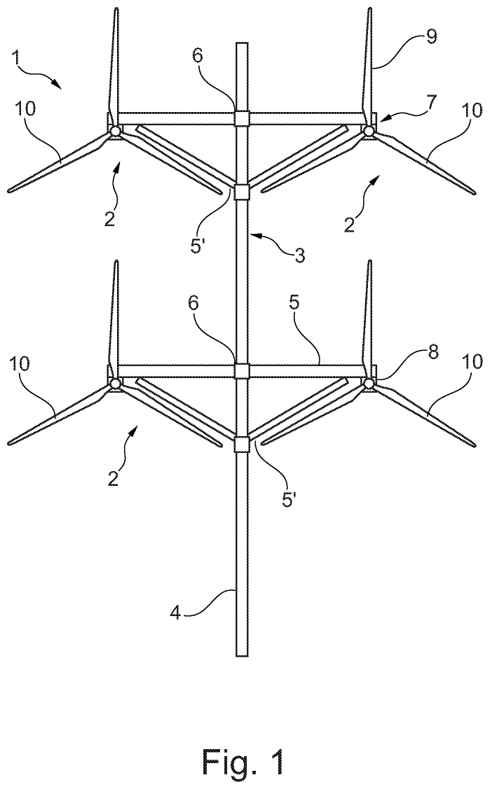

FIG. 1 illustrates a wind turbine 1 comprising a load carrying structure 5, 5′ and four energy generating units 2. A load carrying structure 5 is connected to each of the energy generating units 2 and holds the energy generating unit above ground. The energy generating units 2 house a facility 8 which requires a particular orientation relative to gravity for being operational.

The energy generating unit 2 each comprises an adaptation structure 7 arranged between the load carrying structure 5 and the facility 8. The adaptation structure 7 facilitates a first configuration with a first position of the facility 8 relative to the load carrying structure 5, and a second configuration with a second position of the facility 8 relative to the load carrying structure 5.

The load carrying structures 5, 5′ together with the tower 4 form a tower structure 3. The load carrying structures 5, 5′ are connected to the tower 4 at attachment points 6.

Two load carrying structures 5 are arranged on opposite sides of the tower 4 to thereby balance forces and loads with respect to the tower. The energy generating units 2 are, in the illustrated embodiment, arranged at extremities of the load carrying structures 5, i.e. furthest away from the tower 4.

Each energy generating unit 2 comprises a hub carrying a set of wind turbine blades 10, a generator, and a rotor shaft connecting the generator and the hub. The energy generating unit may further comprise a gear arrangement interconnecting the rotor shaft and the generator.

The facility 8 which in the illustrated embodiment equals a nacelle, comprises at least some of the following components: a component configured for cooling equipment in the energy generating unit, a component configured for lubricating equipment in the energy generating unit, a component configured for electrical control of equipment in the energy generating unit, a component configured for electrical communication between the energy generating unit and external entities, a working platform configured for support of workers in the energy generating unit, and a nacelle cover forming encapsulation of at least a part of the drive train. It may further include a generator and a gearbox.

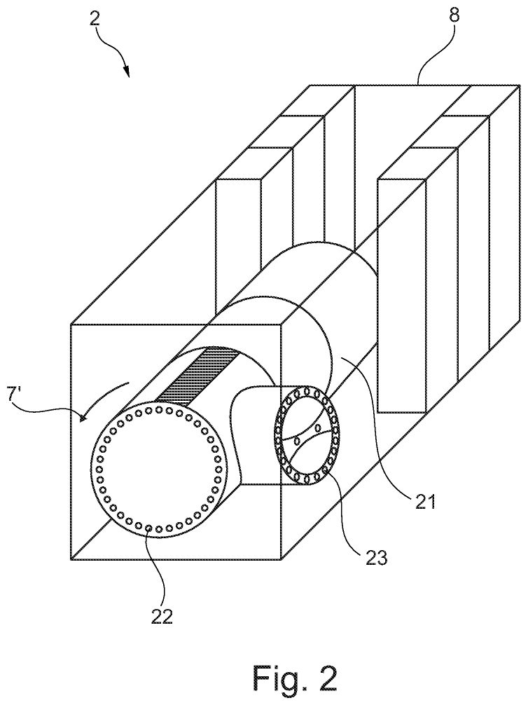

FIG. 2 illustrates a schematic view of a nacelle 2, i.e. an energy generating unit without the rotor. The nacelle comprises a facility 8 and the main frame 21 of the drive train. The first flange 22 is configured for attachment of the rotational part of the drive train; i.e. the hub carrying a set of wind turbine blades.

The second flange 23 is configured for attachment of the energy generating unit 2 to a load carrying structure.

The arrow 7′ illustrates the adaptation structure which facilitates a first configuration with a first position of the facility 8 relative to a load carrying structure, and a second configuration with a second position of the facility 8 relative to a load carrying structure. In the present configuration, the energy generating unit can be connected to a load carrying structure from the side of the facility 8. In the illustrated embodiment, the main frame 121 thereby forms the adaptation structure. It should however be understood, that the adaptation structure may alternatively form part of the main frame or form part of the main bearing system.

When the adaptation structure facilitates another configuration, the energy generating unit may as an example be connected to a load carrying structure from the top of the facility 8 while at the same time keeping at least some of the other elements in the facility in an upright orientation.

Changing from one configuration to another configuration is in the illustrated embodiment achieved by rotation of the main frame 21 which is possible, as the main frame 21 functions independent of the rotational orientation hereof.

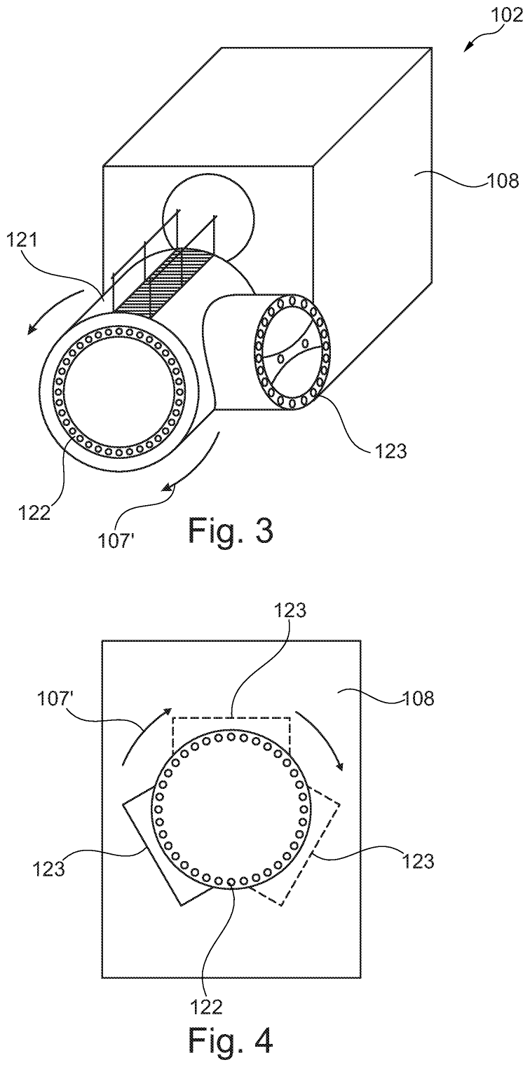

FIG. 3 illustrates a schematic view of an alternative nacelle 102.

The energy generating unit 102 comprising a facility 108 and the main frame 121 of the drive train.

In the illustrated embodiment, the main frame 121 is located outside the facility 108. The arrow 107′ illustrates the adaptation structure which facilitates a first configuration with a first position of the facility 8 relative to a load carrying structure, and a second configuration with a second position of the facility 8 relative to a load carrying structure.

When connecting the energy generating unit 102 to the load carrying structure via the flange 123, the main frame 121 may be attached to the load carrying structure as the first part. When the main frame 121 is attached in the required orientation, the facility 108 may be attached to the main frame 121 e.g. by a flange (not shown). The facility 108 may be attached so that the elements in the facility are in an upright orientation.

The rotational part of the drive train; i.e. the hub carrying a set of wind turbine blades, may subsequently be attached via the flange 122. It should be understood, that the rotational part of the drive train alternatively may be attached to the main frame 121 before attaching the facility 108, and even before attaching the main frame 121 to the load carrying structure.

A hand rail is arranged on top of the main frame 121. It should be understood that the hand rail is optionally, and that the main frame can be provided without the hand rain. Furthermore, it should be understood, that the hand rail may be move to another position, if the main frame 121 is mounted in another orientation, e.g. if the energy generating unit 102 is connected to the load carrying structure via the flange 123 with the flange 123 in an upright position whereby the energy generating unit is positioned below the load carrying structure.

FIG. 4 illustrates a front view of the embodiment of the energy generating unit 102 illustrated in FIG. 3 with indication of different positions of the facility 108 relative to the load carrying structure (not shown). The different positions of the load carrying structure are indicated by the three different positions of the flange 123 for attachment of the energy generating unit 102 to the load carrying structure.

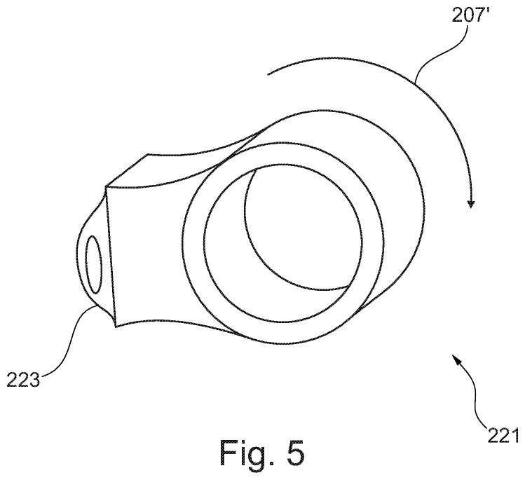

FIG. 5 illustrates a main frame 221 for a drive shaft. The arrow 207′ illustrates the adaptation structure which facilitates a first configuration with a first position of the facility 8 relative to a load carrying structure, and a second configuration with a second position of the facility 8 relative to a load carrying structure. An energy generating unit comprising the main frame 221 may be attached to the load carrying unit by the attachment structure 223.

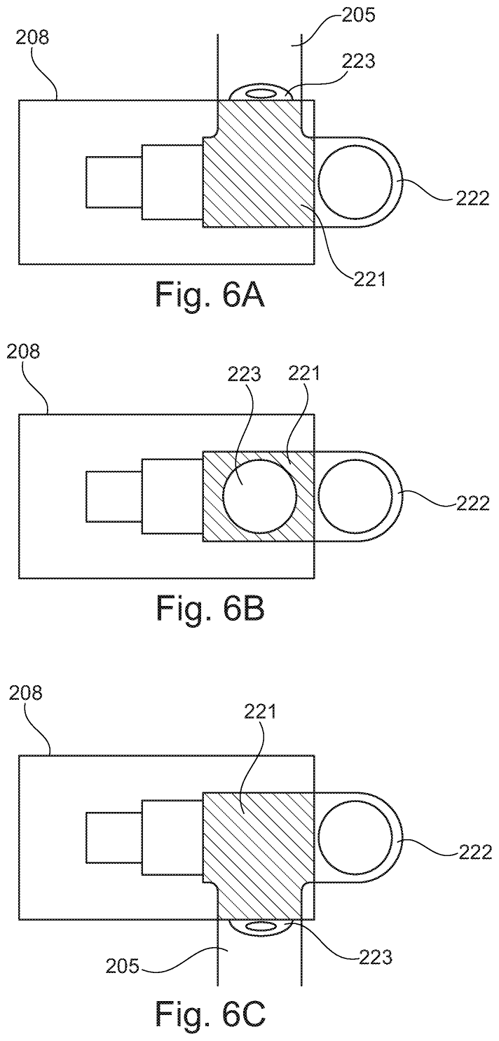

FIGS. 6A-6C illustrate a facility 208 located in different positions relative to a load carrying structure 205. In all the figures, the elements are seen from above.

In FIG. 6A, the facility 208 is attached to the load carrying structure 205 at its right side. In FIG. 6B, the facility 208 is attached to the load carrying structure 205 at its top, and in FIG. 6C, the facility 208 is attached to the load carrying structure 205 at its left side.

The facility 208 is attached to the load carrying structure 205 by the attachments structure 223. The rotational part of the drive train; i.e. the hub carrying a set of wind turbine blades can be attached via the hub 222.

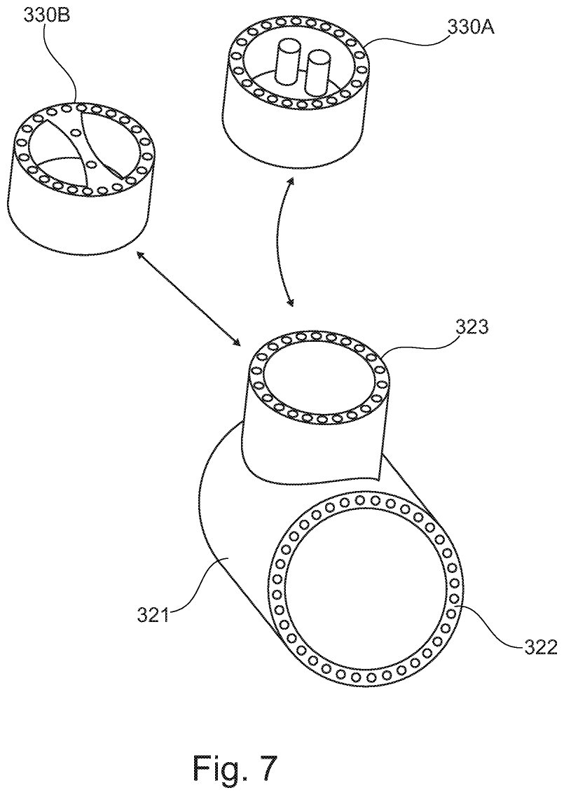

FIG. 7 illustrates different adapter components 330A, 330B and a main frame 321 which facilitates a first configuration with a first position of the facility (not shown) relative to a load carrying structure (not shown), and a second configuration with a second position of the facility relative to a load carrying structure. An energy generating unit comprising the main frame 321 may be attached to the load carrying unit by the attachment structure 323.

The structure 322 allows attachment of the facility or drive train on the main frame.

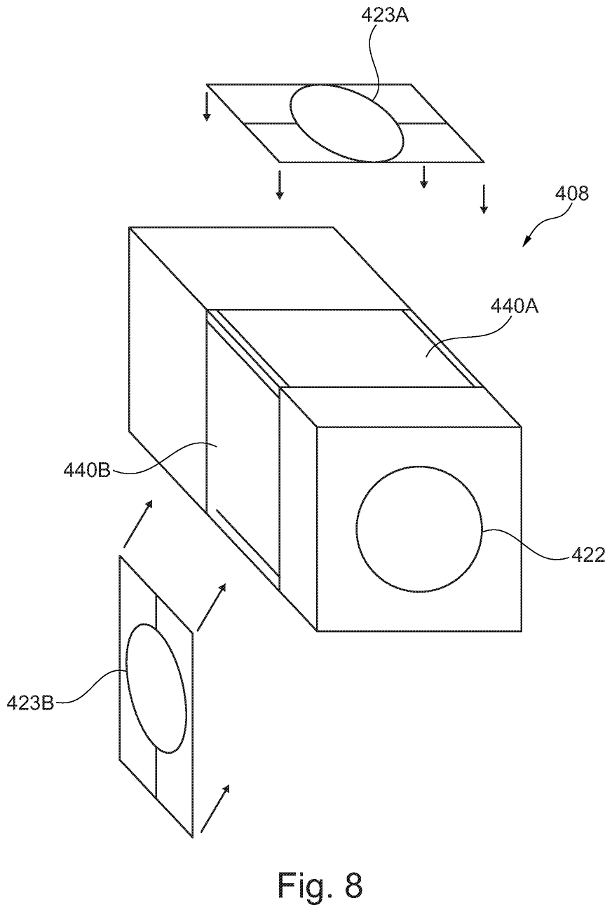

FIG. 8 illustrates an embodiment of a facility 408. The facility comprises an attachment structure 422 for attachment of the rotational part of the drive train, and an attachment structure 423A, 423B for attachment of the energy generating unit to a load carrying structure.

An adaptation structure (not shown) facilitates a first configuration with a first position of the facility 408 relative to the load carrying structure, and a second configuration with a second position of the facility 408 relative to the load carrying structure; i.e. the facility 408 can be positioned below the load carrying structure by use of the first attachment structure 423A and adjacent to the load carrying structure by use of the second attachment structure 423B.

If the first attachment structure 423A is used, a closing element (not shown) may be arranged in front of the opening 440B. On the contrary, is the second attachment structure 423B is used for attachment to the load carrying structure, a closing element may be arranged in front of the opening 440A.

1. A wind turbine comprising a load carrying structure and an energy generating unit, the load carrying structure being connected to the energy generating unit and holding the energy generating unit above ground, the energy generating unit comprising:
a facility,
a rotor shaft defining an axis of rotation, and
a main frame,
the main frame being configured to transfer load from the rotor shaft to the load carrying structure and the facility being a component of the energy generating unit which requires a particular orientation relative to gravity for being operational, wherein the energy generating unit comprises an adaptation structure connecting the facility to the load carrying structure and facilitating a first configuration with a first position of the facility relative to the load carrying structure, and a second configuration with a second position of the facility relative to the load carrying structure.

2. The wind turbine according to claim 1, wherein the position of the main frame is fixed relative to the load carrying structure.

3. The wind turbine according to claim 1, wherein the adaptation structure connects the facility to the load carrying structure via the main frame and wherein the first configuration provides a first position of the facility relative to the main frame, and the second configuration provides a second position of the facility relative to the main frame.

4. The wind turbine according to claim 1, wherein the first position and the second position provide different positions of the facility around the axis of rotation.

5. The wind turbine according to claim 1, wherein the adaptation structure has a first height about ground in the first configuration and a second height about ground in the second configuration.

6. The wind turbine according to claim 1, wherein one of the first and second positions is a position where the adaptation structure is located between the rotor shaft and ground and the other one of the first and second positions is a position where the adaptation structure is not located between the rotor shaft and ground.

7. The wind turbine according to claim 1, wherein the facility comprises at least one element selected from the group consisting of: “a component configured for cooling equipment in the energy generating unit, a component configured for lubricating equipment in the energy generating unit, a component configured for electrical control of equipment in the energy generating unit, a component configured for electrical communication between the energy generating unit and external entities, a working platform configured for support of workers in the energy generating unit, and a nacelle cover forming encapsulation of at least a part of the drive train, a gearbox between the rotor shaft and a generator, and a generator”.

8. The wind turbine according to claim 1, wherein the energy generating unit comprises a nacelle cover forming encapsulation of at least a part of the drive train, and wherein the nacelle cover is not influenced by the change from the first configuration to the second configuration.

9. The wind turbine according to claim 1, wherein at least one of a gearbox and a generator forming part of a drive train are not influenced by the change from the first configuration to the second configuration.

10. The wind turbine according to claim 1, wherein the first position and the second position provides different orientations of the facility relative to the load carrying structure.

11. The wind turbine according to claim 1, wherein the adaptation structure facilitates sliding of the facility relative to the load carrying structure and locking of the sliding in a plurality of positions of the drive train relative to the load carrying structure.

12. The wind turbine according to claim 1, wherein the adaptation structure forms a first flange facilitating attachment of the facility in the first position relative to the load carrying structure and a second flange facilitating attachment of the facility in the second position relative to the load carrying structure.

13. The wind turbine according to claim 1, wherein the adaptation structure is included in an adapter component inserted between the facility and the load carrying structure.

14. The wind turbine according to claim 13, wherein the adapter component forms a lattice structure or a casted structure.

15. The wind turbine according to claim 13, wherein the adapter component, in at least one of the at least two positions is located outside a bottom zone defined between the drive train and ground.

16. The wind turbine according to claim 13, wherein at least one of the first and second positions is a position where the facility is located between the adapter component and ground.

17. The wind turbine according to claim 1, wherein the facility connects a hub and a generator.

18. An energy generating unit for a wind turbine comprising a load carrying structure, the energy generating unit comprising:
a facility,
a rotor shaft defining an axis of rotation, and
a main frame,
the main frame being configured to transfer load from the rotor shaft to the load carrying structure and the facility being a component of the energy generating unit which requires a particular orientation relative to gravity for being operational, wherein the energy generating unit comprises an adaptation structure connecting the facility to the main frame and facilitating a first configuration with a first position of the facility relative to the main frame, and a second configuration with a second position of the facility relative to the main frame.

19. The energy generating unit according to claim 18, wherein the first configuration and second configuration provide different orientation of the facility relative to the main frame.

20. The energy generating unit according to claim 18, wherein the adaptation structure facilitates sliding of the facility relative to the main frame and locking of the sliding in a plurality of positions of the facility relative to the main frame.

21. The energy generating unit according to claim 18, wherein the adaptation structure forms a first flange facilitating attachment of the facility in the first position relative to the main frame and a second flange facilitating attachment of the facility in the second position relative to the main frame.

22. The energy generating unit according to claim 18, wherein the adaptation structure is included in an adapter component configured for insertion between the facility and the main frame.

23. The energy generating unit according to claim 18, wherein the adapter component forms a lattice structure or a casted structure.

24. The energy generating unit according to claim 18, wherein one of the first position and second position is a position where the rotor shaft is below the facility, and the other one of the first position and second position is a position where the adaptation structure is not below the rotor shaft.

25. A method for assembling or servicing a wind turbine according to claim 1, the method comprising the steps of selecting between the first and the second configurations to provide a required orientation of the facility, the selection depending on a layout of the load carrying structure.
